(19) United States
(12) Patent Application Publication
(10) Pub. No.: US 2017/0184050 A1
(43) Pub. Date: Jun. 29, 2017

(54) CYLINDER BLOCK FOR ENGINE

(71) Applicant: Caterpillar Inc., Peoria, IL (US)

(72) Inventor: Suresh Kumar Gurusamy, Chennai (IN)

(73) Assignee: Caterpillar Inc., Peoria, IL (US)

(21) Appl. No.: 15/455,315

(22) Filed: Mar. 10, 2017

(30) Foreign Application Priority Data
Mar. 28, 2016 (IN) 201611010551

(51) Int. Cl. F02F 1/00; F02F 1/18; F02F 11/00; F02F 1/24

(52) U.S. Cl. CPC F02F 1/004; F02F 1/24; F02F 1/18; F02F 11/005

(57) ABSTRACT

An engine is disclosed. The engine includes a cylinder block having a bore and a cylinder head. The engine includes a spacer plate disposed between the cylinder block and the cylinder head. The spacer plate includes an aperture having a first taper portion. The engine also includes a cylinder liner having a fourth surface and received in the bore of the cylinder block. The fourth surface includes a second portion. The fourth surface also includes a second taper portion extending from the second portion and inclined at an angle with respect to the second portion. The second portion and the second taper portion define a fillet. The fourth surface includes a third portion extending from the second taper portion. The third portion defines a differential angle with respect to the second taper portion. The fourth surface also includes a sealing portion abutting the first taper portion of the spacer plate.

### TECHNICAL FIELD

The present disclosure relates to an engine, and more specifically relates to a liner and cylinder block assembly of the engine.

### BACKGROUND

Generally, an engine, such as a diesel engine, a gasoline engine, or a gaseous fuel engine, includes a cylinder block having a plurality of bores. A cylinder liner is disposed in each of the bores to define a cylinder for the engine and to withstand wear from a piston reciprocating inside the cylinder. Conventionally, the cylinder liner includes an annular flange of generally rectangular cross-section, supported on the cylinder block. During an operation of the engine, the cylinder liner may be exposed to various loads, such as clamping load, piston load, and cylinder pressure, which lead to formation of fatigue cracks in the cylinder liner. Moreover, the annular flange experiences stresses, such as circumferential stress and axial stress that lead to stress concentration at a fillet defined at the flat rectangular flange, thereby causing catastrophic failure of the engine.

Currently, various cold working processes, such as roll burnishing and shot peening, are employed to induce an amount of residual compressive stress in the cylinder liner, thereby increasing fatigue strength of the cylinder liner to withstand the various loads during the operation of the engine. However, performing the cold working processes on the cylinder liner demands more time and high cost.

U.S. Pat. No. 7,334,546, hereinafter referred to as '546 patent, discloses a ductile repair cylinder liner for a diesel engine. The cylinder liner includes an additional cooling groove with a parabolic varying cross-section machined into the second surface of the cylinder liner immediately below the radially extending locating flange for the liner. However, the radially extending locating flange of the cylinder liner disclosed in the '546 patent may experience fatigue cracks.

### SUMMARY OF THE DISCLOSURE

In one aspect of the present disclosure, an engine is provided. The engine includes a cylinder block having a first abutment surface and a bore extending from the first abutment surface along a longitudinal axis. The bore includes an abutment portion. The engine also includes a cylinder head adapted to couple with the cylinder block. The cylinder head includes a second abutment surface. The engine includes a spacer plate disposed between the cylinder block and the cylinder head. The spacer plate includes a first surface adapted to abut the second abutment surface of the cylinder head. The spacer plate also includes a second surface adapted to abut the first abutment surface of the cylinder block. The spacer plate includes an aperture having a first taper portion, at an inner peripheral thereof, extending between the first surface and the second surface. The engine also includes a cylinder liner received in the bore of the cylinder block. The cylinder liner includes an annular surface adapted to abut the second abutment surface of the cylinder head. The cylinder liner also includes a third surface extending from the annular surface along the longitudinal axis. The cylinder liner includes a fourth surface distal to the third surface and extending from the annular surface. The fourth surface includes a first portion abutting the abutment portion of the cylinder block. The fourth surface includes a second portion defined between the annular surface and the first portion. The second portion of the cylinder liner and the abutment portion of the cylinder block are adapted to receive a sealing liner therebetween. The fourth surface also includes a second taper portion extending from the second portion and inclined at an angle with respect to the second portion. The second portion and the second taper portion define a fillet. The fourth surface includes a third portion extending from the second taper portion. The third portion defines a differential angle with respect to the second taper portion. The fourth surface also includes a sealing portion. The sealing portion is defined between the second taper portion and the third portion. The sealing portion is adapted to abut the first taper portion of the spacer plate.

Other features and aspects of this disclosure will be apparent from the following description and the accompanying drawings.

### BRIEF DESCRIPTION OF THE DRAWINGS

FIG. 1 is a partial exploded view of an engine having a cylinder liner and a cylinder block, according to an embodiment of the present disclosure;

FIG. 2 is a partial sectional view of the engine showing the cylinder liner disposed within the cylinder block of FIG. 1;

FIG. 3 is a partial sectional view of the cylinder liner taken along line A-A′ of FIG. 1;

FIG. 4 is an enlarged view of an encircled region “A” of FIG. 2 showing the cylinder liner and the cylinder block; and

FIG. 5 is a view of a cylinder liner disposed within a cylinder block of an engine, according to another embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

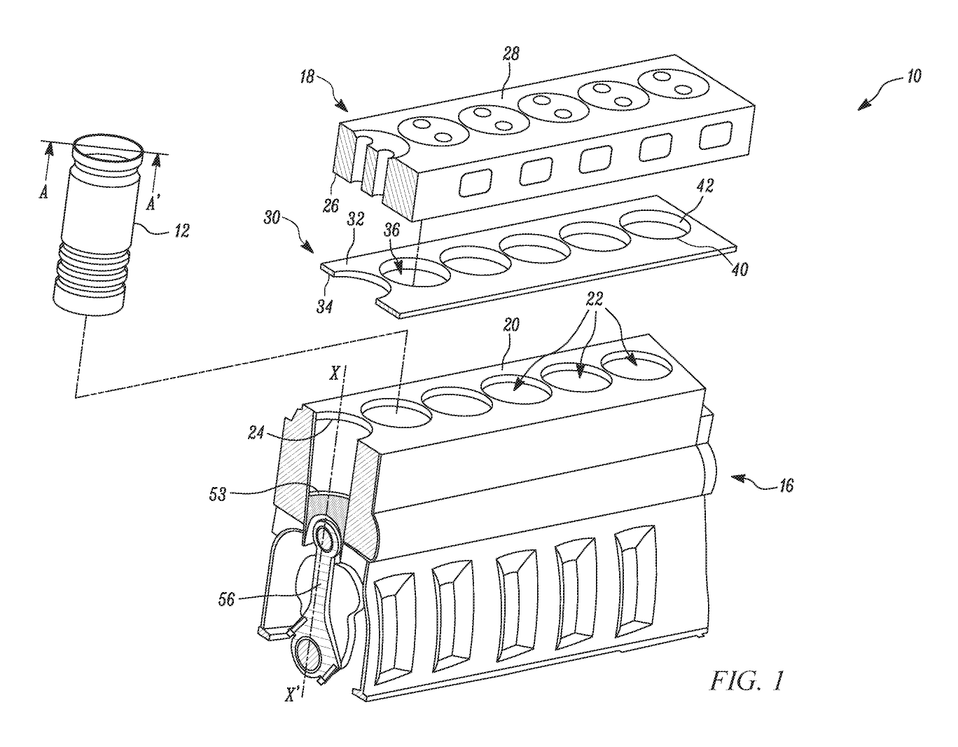

FIG. 1 illustrates a partial exploded view of an engine 10 with a cylinder liner 12, according to one embodiment of the present disclosure. The engine 10 is embodied as a compression ignition engine. In various examples, the engine 10 may be any type of engine, such as internal combustion engine run by gasoline, diesel, gaseous fuel, or a combination thereof. The engine 10 may be used as a source of power for any machine, such as on-highway trucks, off-highway trucks, and earth moving equipment, and various devices, such as pumps, stationary equipment, and generators. The engine 10 may also be used to power machines or devices used in construction, transportation, power generation, aerospace applications, locomotive applications, marine applications, and any other applications that require a rotary power. Although the engine 10, shown in FIG. 1, is a multi cylinder engine, it may be contemplated that the present disclosure may be implemented in a single cylinder engine.

The engine 10 includes a cylinder block 16 and a cylinder head 18. Although not shown, the engine 10 may include, but is not limited to, a front cover and an oil pan coupled to the cylinder block 16. The cylinder block 16 includes a first abutment surface 20. The cylinder block 16 further includes a number of bores 22 extending from the first abutment surface 20. Each of the number of bores 22 extends from the first abutment surface 20 along a longitudinal axis X-X′. In the illustrated example, six bores 22 are shown in an inline configuration. Each of the bores 22 includes an abutment portion 24 for defining a cylinder for the engine 10. Although, the bores 22 are defined in an inline configuration in the cylinder block 16, it should be understood that the bores 22 can be defined in any type of configuration, such as a V-type configuration and a radial configuration.

The cylinder head 18 is adapted to couple with the cylinder block 16 of the engine 10. The cylinder head 18 includes a second abutment surface 26 and a third abutment surface 28. For illustration purpose, the present disclosure will be described in connection with one of the bores 22 of the cylinder block 16, although it will be understood that the present disclosure is equally applicable to other bores 22 of the cylinder block 16.

The engine 10 also includes a spacer plate 30. The spacer plate 30 is disposed between the cylinder block 16 and the cylinder head 18. More specifically, the spacer plate 30 is fastened to the cylinder block 16 and the cylinder head 18. The spacer plate 30 includes a first surface 32, a second surface 34, and an aperture 36. The first surface 32 abuts the second abutment surface 26 of the cylinder head 18. In one example, the first surface 32 abuts a first gasket (not shown) positioned between the second abutment surface 26 of the cylinder head 18 and the first surface 32 of the spacer plate 30.

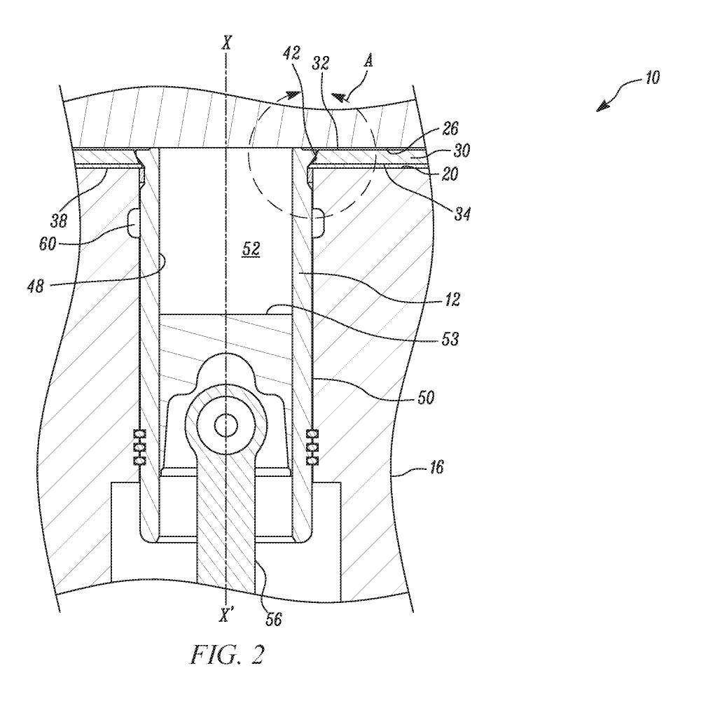

The second surface 34 of the spacer plate 30 abuts the first abutment surface 20 of the cylinder block 16. In one example, the second surface 34 may abut a second gasket 38 (shown in FIG. 2) positioned between the first abutment surface 20 of the cylinder block 16 and the second surface 34 of the spacer plate 30. The aperture 36 is adapted to coaxially align with the bore 22 of the cylinder block 16. The aperture 36 has an inner periphery 40 having a first taper portion 42. The first taper portion 42 extends between the first and second surfaces 32, 34 of the spacer plate 30.

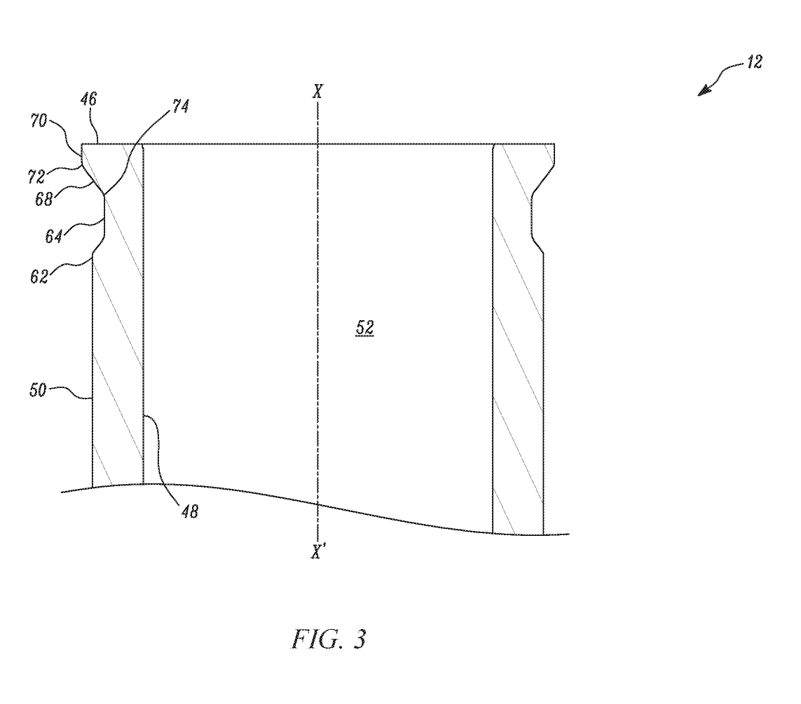

FIG. 2 illustrates a partial sectional view of the engine 10 having the cylinder liner 12 disposed in the cylinder block 16. FIG. 3 illustrates a partial sectional view of the cylinder liner 12 taken along a line A-A′ of FIG. 1. Referring to FIG. 2 and FIG. 3, the cylinder liner 12 is received in the bore 22 of the cylinder block 16. More specifically, the cylinder liner 12 is removably disposed within the bore 22 of the cylinder block 16. The cylinder liner 12 includes an annular surface 46, a third surface 48, and a fourth surface 50. The annular surface 46 abuts the second abutment surface 26 of the cylinder head 18 of the engine 10. The third surface 48 extends form the annular surface 46 along the longitudinal axis X-X′. The third surface 48 defines a cavity 52 within which a piston 53 is adapted to reciprocate along the longitudinal axis X-X′. The piston 53 is coupled to a connecting rod 56 of the engine 10.

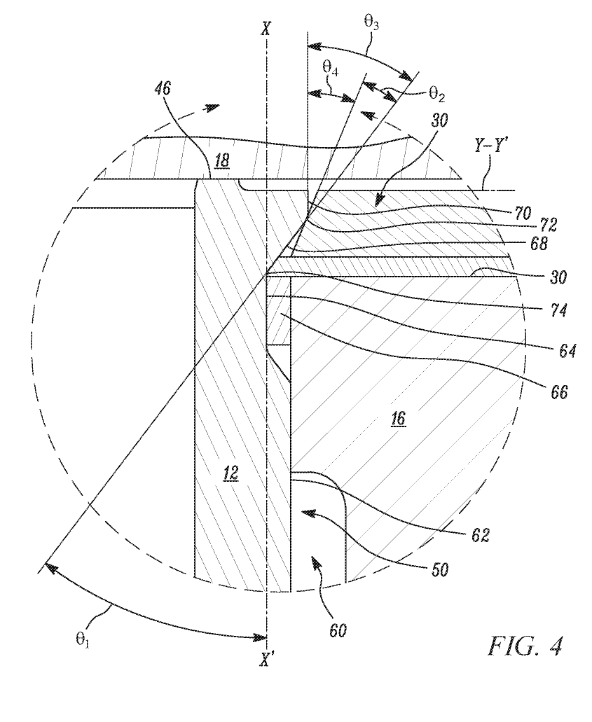

FIG. 4 shows an enlarged view of an encircled region “A” of FIG. 2 showing the cylinder liner 12 and the cylinder block 16. Referring to FIG. 3 and FIG. 4, the fourth surface 50 extends from the annular surface 46 along the longitudinal axis X-X′. The fourth surface 50 is defined to form a number of cavities 60 within the bore 22 to receive coolant therein.

Referring to FIGS. 2 to 4, the fourth surface 50 includes a first portion 62 and a second portion 64. The first portion 62 abuts the abutment portion 24 (shown in FIG. 1) of the cylinder block 16. The second portion 64 is defined between the annular surface 46 and the first portion 62. The second portion 64 and the abutment portion 24 of the cylinder block 16 are adapted to receive a sealing liner 66 (shown in FIG. 4) therebetween. In one example, the sealing liner 66 is provided to restrict leakage of the coolant from the cavities 60 formed between the abutment portion 24 of the cylinder block 16 and the fourth surface 50 of the cylinder liner 12 to the first abutment surface 20 of the cylinder block 16.

Further, the fourth surface 50 includes a second taper portion 68. The second taper portion 68 extends from the second portion 64 of the cylinder liner 12. The second taper portion 68 is inclined at an angle “θ₁” with respect to the second portion 64. In an example, the angle “θ₁” may be in a range of 20 degrees to 30 degrees. The second portion 64 and the second taper portion 68 define a fillet 74. The fillet 74 is provided to distribute a stress concentration caused by external loads acting on the cylinder liner 12 to a wider surface area. The external loads may include, but is not limited to, clamping loads, piston thrust loads, and a combustion pressure acting on the cylinder liner 12 during operation of the engine 10. In one example, the angle “θ₁” can be varied to attain larger fillet radius of the fillet 74, thereby further increasing the wider surface area for distributing the stress concentration.

Further, the second taper portion 68 is inclined at an angle “θ₂” with respect to the first taper portion 42 of the spacer plate 30. In an example, the angle “θ₂” may be in a range of 10 degrees to 20 degrees. The fourth surface 50 also includes a third portion 70 extends from the second taper portion 68 of the cylinder liner 12. More specifically, the third portion 70 extends from the second taper portion 68 towards the annular surface 46 of the cylinder liner 12. The third portion 70 defines a differential angle “θ₃” with respect to the second taper portion 68. Also, the third portion 70 is inclined at an angle “θ₄” with respect to the first taper portion 42 of the spacer plate 30. The fourth surface 50 includes a sealing portion 72 defined between the second taper portion 68 and the third portion 70. The sealing portion 72 abuts the first taper portion 42 of the spacer plate 30, thereby aligning the annular surface 46 of the cylinder liner 12 with the first surface 32 of the spacer plate 30 along a transverse axis Y-Y′ in an assembled position of the engine 10. In one example, the sealing portion 72 is hardened by using a surface hardening process for providing a hardened surface at the sealing portion 72. In one example, the sealing portion 72 forms a line contact with the first taper portion 42 of the spacer plate 30. In another example, the sealing portion 72 forms a surface contact with the first taper portion 42 of the spacer plate 30.

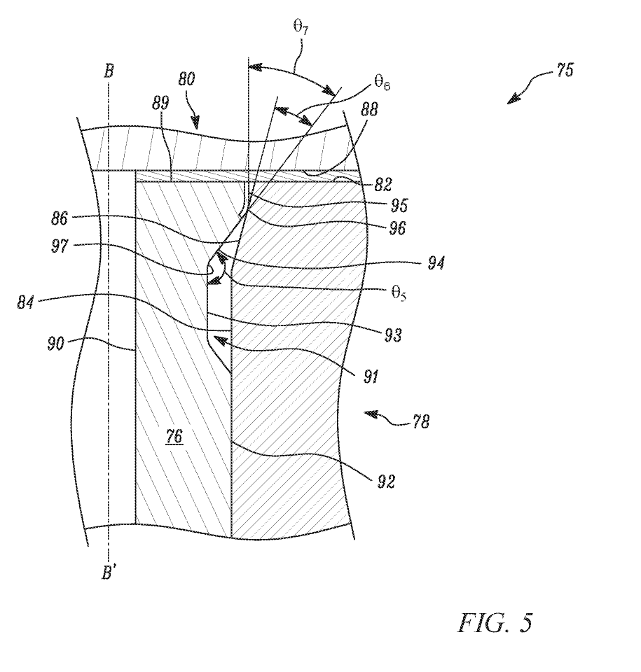

FIG. 5 illustrates a partial sectional view of an engine 75 having a cylinder liner 76 disposed in a cylinder block 78, according to another embodiment of the present disclosure. Similar to the engine 10 of the FIG. 1, the engine 75 includes the cylinder block 78 and a cylinder head 80. The cylinder block 78 includes a first abutment surface 82, an abutment portion 84, and a first taper portion 86. The first taper portion 86 extends between the first abutment surface 82 and the abutment portion 84 of the cylinder block 78. The cylinder head 80 is coupled to the cylinder block 78 of the engine 75. The cylinder head 80 includes a second abutment surface 88 and a third abutment surface (not shown).

Further, similar to the cylinder liner 12 of the FIGS. 1 to 4, the cylinder liner 76 includes an annular surface 89, a first surface 90, and a second surface 91. The annular surface 89 is adapted to abut the second abutment surface 88 of the cylinder head 80 of the engine 75. The first surface 90 extends from the annular surface 89 along a longitudinal axis B-B′. The second surface 91 is distal to the first surface 90 and extends from the annular surface 89 along the longitudinal axis B-B′.

The second surface 91 includes a first portion 92 and a second portion 93. The first portion 92 abuts the abutment portion 84 of the cylinder block 78. The second portion 93 is defined between the annular surface 89 and the first portion 92. The second surface 91 also includes a second taper portion 94. The second taper portion 94 extends from the second portion 93. More specifically, the second taper portion 94 extends from the second portion 93 towards the annular surface 89. The second taper portion 94 is inclined at an angle “θ₅” with respect to the second portion 93. Also, the second taper portion 94 is inclined at an angle “θ₆” with respect to the first taper portion 86 of the cylinder block 78. The second portion 93 and the second taper portion 94 define a fillet 97. The fillet 97 is provided to distribute a stress concentration caused by the external loads acting on the cylinder liner 76.

The second surface 91 also includes a third portion 95. The third portion 95 extends from the second taper portion 94. More specifically, the third portion 95 extends from the second taper portion 94 towards the annular surface 89. The third portion 95 defines a differential angle “θ₇” with respect to the second taper portion 94. Further, the second surface 91 includes a sealing portion 96. The sealing portion 96 is defined between the second taper portion 94 and the third portion 95. The sealing portion 96 is adapted to abut the first taper portion 86 of the cylinder block 78. The sealing portion 96 is provided to restrict leakage of the coolant from a number of cavities (not shown) formed between the abutment portion 84 and the second surface 91. The sealing portion 96 is hardened by using a surface hardening process. The surface hardening process may include, but is not limited to, a flame and induction hardening process, a carburizing process, a cyaniding process, and a carbonitriding process. The sealing portion 96 includes a hardened surface having a thickness that forms metal to metal contact with the first taper portion 86 of the cylinder block 78. The thickness of the hardened surface may be varied based on various parameters including, but not limited to, material of the cylinder liner 12 and various loads, such as clamping load, piston load, and cylinder pressure. It should be noted that rest of the construction of the engine 10 of FIG. 1 is similar to the construction of the engine 75 of FIG. 5.

### INDUSTRIAL APPLICABILITY

The present disclosure relates to the cylinder liners 12, 76 for the cylinder blocks 16, 78 of the engines 10, 75, respectively. The cylinder liner 12 includes the fourth surface 50 having the second taper portion 68 inclined at the angle “θ₁” with respect to the second portion 64. The second portion 64 and the second taper portion 68 define the fillet 74 that reduces the stress concentration and eliminates notch effect at the fillet 74. The cylinder liner 12 includes the sealing portion 72 defined between the second taper portion 68 and the third portion 70. The sealing portion 72 abuts the first taper portion 42 of the spacer plate 30, which firmly holds the cylinder liner 12 within the cylinder block 78 of the engine 10. This eliminates the requirement of cantilever support structure used in a convectional cylinder liner for holding the conventional cylinder liner within the cylinder block 16.

The cylinder liner 12 can be used in any type of engine, such as internal combustion engines run by gasoline, diesel, gaseous fuel, or a combination thereof. Further, the cylinder liner 12 can be employed in the engine 10 of any type of machine used in construction, transportation, power generation, aerospace applications, locomotive applications, marine applications, and other engine power applications. Therefore, the cylinder liner 12 has a wide range of application across industries. Moreover, the cylinder liner 12 can be conveniently retrofittable with the engine 10. Therefore, the present disclosure offers the engine 10 with the cylinder liner 12 that is economical and cost effective.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

What is claimed is:

1. An engine comprising:
a cylinder block including a first abutment surface and a bore extending from the first abutment surface along a longitudinal axis, the bore includes an abutment portion;
a cylinder head adapted to couple with the cylinder block, the cylinder head including a second abutment surface;
a spacer plate disposed between the cylinder block and the cylinder head, the spacer plate including a first surface adapted to abut the second abutment surface of the cylinder head, a second surface adapted to abut the first abutment surface of the cylinder block, and an aperture including a first taper portion, at an inner periphery thereof, extending between the first surface and the second surface; and
a cylinder liner received in the bore of the cylinder block, the cylinder liner including:
an annular surface adapted to abut the second abutment surface of the cylinder head;
a third surface extending from the annular surface along the longitudinal axis; and
a fourth surface extending from the annular surface, and distal to the third surface, the fourth surface including:
a first portion abutting the abutment portion of the cylinder block;
a second portion defined between the annular surface and the first portion, the second portion and the abutment portion of the cylinder block adapted to receive a sealing liner therebetween;
a second taper portion extending from the second portion and inclined at an angle with respect to the second portion, wherein the second portion and the second taper portion define a fillet;
a third portion extending from the second taper portion, and defining a differential angle with respect to the second taper portion; and
a sealing portion defined between the second taper portion and the third portion, wherein the sealing portion is adapted to abut the first taper portion of the spacer plate.
